(19) United States
(12) Patent Application Publication
(10) Pub. No.: US 2006/0084711 A1
(43) Pub. Date: Apr. 20, 2006

(54) Foaming mixtures

(76) Inventors: Volker Stanjek, Munchen (DE); Willibald Lottner, Weilheim (DE); Felicitas Schauer, Aying (DE); Christine Knezevic, Munchen (DE); Richard Weidner, Burhausen (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/545,508

(22) PCT Filed: May 13, 2004
(86) PCT No.: PCT/EP04/05156

§ 371 Date: Aug. 12, 2005

(30) Foreign Application Priority Data
May 22, 2003 (DE) 103 23 206.0

(51) Int. Cl. C08G 77/00

(52) U.S. Cl. 521/154

(57) ABSTRACT

Foamable compositions which are preferably isocyanate-free and which exhibit good foaming properties including short application times and freedom from cracks in the cured foam, are obtained from alkoxysilane-terminated prepolymers preferably containing polyurethane moieties, a blowing agent component, and a solvent having a boiling point in excess of 30° C.

The invention relates to foamable mixtures and pressure vessels containing the foamable mixtures.

Sprayable in-situ foams are employed for filling hollow spaces, in particular in the building sector. Here, they are used, inter alia, for sealing joins, e.g. around windows and doors, and act as excellent insulating materials so as to give good thermal insulation. Further applications are, for example, insulation of pipes or filling hollow spaces in industrial appliances with foam.

All conventional in-situ foams are polyurethane foams (PU foams) which in the uncrosslinked state comprise prepolymers which have a high concentration of free isocyanate groups. These isocyanate groups are able to undergo addition reactions with suitable reaction partners even at room temperature, as a result of which curing of the spray foam is achieved after application. The foam structure is produced by incorporating a volatile blowing agent into the as yet uncrosslinked raw material and/or by means of carbon dioxide formed by reaction of isocyanates with water. The foam is generally ejected from pressure cans by means of the autogenous pressure of the blowing agent.

Reaction partners employed for the isocyanates are alcohols having two or more OH groups, especially branched and unbranched polyols, or else water. The latter reacts with isocyanates to liberate carbon dioxide, as mentioned above, and form primary amines which can then add directly onto a further, as yet unconsumed isocyanate group. This results in formation of urethane and urea units which, owing to their high polarity and their ability to form hydrogen bonds in the cured material, can form partially crystalline substructures and thus lead to foams having a high hardness, pressure resistance and ultimate tensile strength.

Blowing agents used are mostly gases which are condensable at a relatively low pressure and can thus be mixed in the liquid state into the prepolymer mixture without the spray cans having to be subjected to excessively high pressures. In addition, the prepolymer mixtures may contain further additives such as foam stabilizers, emulsifiers, flame retardants, plasticizers and catalysts. The latter are usually organic tin(IV) compounds or tertiary amines. However, iron(III) complexes, for example, are also suitable.

PU spray foams are produced both as one-component (1K) foams and as two-component (2K) foams. The 1K foams cure exclusively through contact of the isocyanate-containing prepolymer mixture with atmospheric moisture. Foam formation can additionally be aided by the carbon dioxide liberated during the curing reaction of 1K foams. 2K foams comprise an isocyanate component and a polyol component which have to be mixed well with one another immediately before foaming and cure as a result of the reaction of the polyol with the isocyanates. An advantage of the 2K systems is an extremely short curing time of sometimes only a few minutes for complete curing. However, they have the disadvantage that they require a complicated pressure can having two chambers and, in addition, are significantly less comfortable to handle than the 1K systems.

The cured PU foams display, in particular, excellent mechanical and thermal insulation properties. Furthermore, they have very good adhesion to most substrates and are stable virtually indefinitely under dry and UV-protected conditions. Further advantages are the toxicological acceptability of the cured foams from the point in time at which all isocyanate units have reacted quantitatively, and their swift curing and their easy handling. Due to these properties, PU foams have been found to be very useful in industrial practice.

Nevertheless, PU spray foams have the critical disadvantage that the isocyanate groups can, owing to their high reactivity, also develop a serious irritant action and toxic effects. In addition, the amines which can be formed by reaction of monomeric diisocyanates with an excess of water are in many cases suspected of being carcinogenic. Such monomeric diisocyanates are likewise present in addition to the isocyanate-terminated prepolymers in most spray foam mixtures. The uncrosslinked spray foam compositions are thus toxicologically unacceptable until they are completely cured. Critical factors here are not only direct contact of the prepolymer mixture with the skin but also, in particular, possible aerosol formation during application of the foam or vaporization of low molecular weight constituents, e.g. monomeric isocyanates. This results in the risk of toxico-logically unacceptable compounds being taken up via inhaled air. In addition, isocyanates have a considerable allergenic potential and can, inter alia, trigger asthma attacks. These risks are increased by the fact that the PU spray foams are often not used by trained and practiced users but by handymen and home workers, so that correct handling cannot always be assumed.

The hazard potential exhibited by conventional PU foams and the associated compulsory labeling has additionally resulted in the problem of considerably decreasing acceptance of the corresponding products by users. In addition, completely or partly emptied spray cans are classified as hazardous waste and have to be labeled accordingly and in some countries, e.g. Germany, even have to be made available for reuse by means of a costly recycling system.

In order to overcome these disadvantages, DE-A-43 03 848, inter alia, has described prepolymers for spray foams which contain no monomeric isocyanates or contain only low concentrations of these. However, a disadvantage of such systems is the fact that the prepolymers always still have isocyanate groups, so that such PU spray foams may well be better than conventional foams from a toxicological point of view but cannot be described as nonhazardous. In addition, the acceptance and waste problems are not solved by such foam systems.

It would therefore be desirable to have prepolymers which do not crosslink via isocyanate groups and are thus toxicologically acceptable available for the production of spray foams. Moreover, these prepolymer mixtures should make it possible to produce spray foams which in the cured state have similarly good properties and, in particular, a comparable hardness compared to conventional isocyanate-containing PU foams. In addition, one-component spray foam systems which cure exclusively through contact with atmospheric moisture also have to be possible. These should display comparably problem-free handling and processability including a high curing rate even at a low catalyst concentration. The latter is important particularly since the organotin compounds generally used as catalysts are likewise problematical from a toxicological point of view.

On this subject, the literature, e.g. U.S. Pat. No. 6,020,389, describes condensation-crosslinking silicone foams which comprise alkoxy-, acyloxy- or oximo-terminated silicone prepolymers. Such foamable mixtures are in principle suitable for producing 1K foams which cure at room temperature only through atmospheric moisture. However, such systems comprising purely silicone-containing prepolymers can be used only for producing elastic flexible to semi-rigid foams. They are not suitable for producing rigid in-situ foams.

EP-1098920-A, DE-10108038-A and DE-10108039-A describe prepolymer mixtures comprising alkoxysilane-terminated prepolymers for producing rigid spray foams. These are polymers having an organic backbone which generally has a conventional polyurethane structure. In EP-1098920-A and DE-10108038-A, this organic backbone is formed by reaction of customary diisocyanates with polyols. Here, an appropriate excess of diisocyanates is used so that isocyanate-terminated prepolymers are obtained. These can then be reacted with 3-aminopropyltrimethoxysilane derivatives in a second reaction step to form the desired alkoxysilane-terminated polyurethane prepolymers. In DE-10108038-A, a specific reactive diluent is added to the silane-terminated prepolymers. DE-10108039-A describes a second process for preparing alkoxysilane-terminated prepolymers, in which these prepolymers are formed by reaction of hydroxy-functional polyols with 3-isocyanatopropyltrimethoxy-silane.

These alkoxysilane-terminated prepolymers and any reactive diluents present can condense with one another in the presence of a suitable catalyst and of water with elimination of methanol and as a result cure. The water can be added as such or can originate from contact with atmospheric moisture. Both 1K and 2K foams can thus be produced using such a system.

However, the alkoxysilane-terminated polyurethane prepolymers described in EP-1098920-A, DE-10108038-A and DE-10108039-A have, inter alia, the disadvantage of a relatively low reactivity toward atmospheric moisture. For this reason, high concentrations of a tin catalyst are necessary to achieve sufficiently rapid curing.

A significant improvement is provided by a system described in WO 02/066532. The alkoxysilane-terminated prepolymers described here for producing isocyanate-free spray foams comprise silane end groups of the general formula [1] 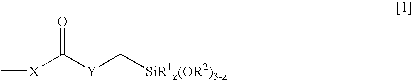
where:
X and Y are each an oxygen atom, an N—R group or a sulfur atom,
R¹ is an alkyl, cycloalkyl, alkenyl or aryl radical having 1-10 carbon atoms,
R² is an alkyl radical having 1-2 carbon atoms or an ω-oxaalkylalkyl radical having a total of 2-10 carbon atoms,
R is a hydrogen atom, an alkyl, alkenyl or aryl radical having 1-10 carbon atoms or a —CH₂—SiR¹_{z}(OR²)_{3-z} group and
z is 0 or 1,
   with the proviso that at least one of the two groups X and Y is an NH function.

In these alkoxysilyl-terminated prepolymers, the crosslinkable alkoxysilyl groups are separated from a urethane or urea unit only by one methyl spacer. These prepolymers are astonishingly reactive toward water and thus have extremely short tack-free times in the presence of atmospheric moisture and can even be crosslinked in the absence of tin.

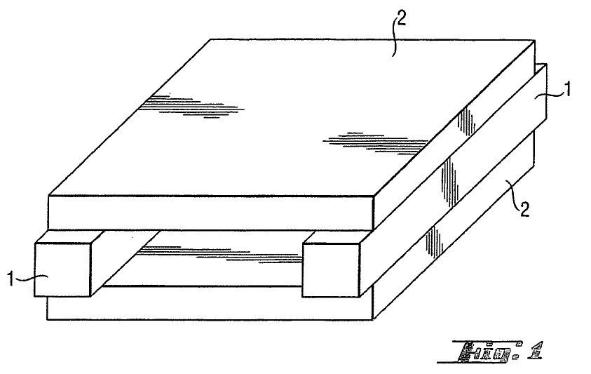

A further critical disadvantage of silane-terminated prepolymers for spray foam applications could, on the other hand, be overcome in none of the patent literature mentioned. Thus, all silane-crosslinking foams of the prior art display crack formation under certain conditions. This crack formation is particularly pronounced when the foam is foamed in a model join as shown in FIG. 1 whose wooden boards have been moistened beforehand. This crack formation may be explained by the following theory, which was developed in the context of the work presented here. This crack formation is attributable to the polar blowing agents used in the prior art. This is because the diffusion of these polar blowing agents through the foam lamellae, which are likewise composed of polar material, proceeds significantly more quickly than the diffusion of nonpolar air occurring in the opposite direction. This can lead to shrinkage and subsequently rupture of the only partially cured and thus not sufficiently cracking-resistant foam, because, unlike in the case of conventional PU foams, curing does not result in liberation of carbon dioxide which could compensate the blowing agent shrinkage until curing of the foam is concluded.

Crack formation can be avoided if nonpolar blowing gases, for example volatile hydrocarbons such as propane/butane mixtures are used as blowing agents, since these nonpolar blowing agents diffuse significantly more slowly through the foam lamellae and out of the foam, so that the foam no longer displays a tendency to shrink and to form cracks. However, a disadvantage of this measure is the fact that nonpolar blowing agents such as propane/butane are incompatible with the silane-terminated prepolymers according to the prior art. Although foamable emulsions can be produced using prepolymers of the prior art and propane/butane, these are not stable on storage and can no longer be foamed after demixing has occurred. Owing to the high viscosity of the silane-terminated prepolymers of the prior art at room temperature, reemulsification is likewise not possible.

Further measures are therefore necessary to obtain solutions comprising silane-terminated prepolymers and blowing agents which have a sufficiently low viscosity.

One way of reducing the viscosity of solutions comprising silane-terminated blowing agents and nonpolar blowing agents is to use blowing agent mixtures which comprise not only nonpolar blowing agents but also a proportion of polar blowing agents which have a significantly better solubility in the prepolymer. Examples which may be mentioned here are dimethyl ether and fluorinated blowing agents such as 1,1,1,2-tetrafluoroethane or 1,1-difluoroethane. However, the effectiveness of this measure is limited, since these blowing agents can, as described above, diffuse very quickly through the lamellae of the (partially) cured foam. Thus, if these blowing agents are present in concentrations which are too high, they once again increase the tendency for shrinkage of the foam and crack formation to occur. Accordingly, foams having a content of polar blowing agents which is too high display cracks when foamed in the model join shown in FIG. 1. In addition, all fluorine-containing blowing gases are regarded as critical because of their action as greenhouse gases and have already been banned in some countries, e.g. Denmark, for spray foam applications.

It was an object of the present invention to provide mixtures based on isocyanate-free prepolymers which are suitable for producing spray foams which remain crack-free when foamed and at the same time have a viscosity which is sufficiently low for them to be able to be foamed readily.

The invention provides foamable mixtures (M) comprising
(A) isocyanate-free, alkoxysilane-terminated prepolymers (A) which have silane end groups of the general formula [2]
   —SiR³_{z}(OR⁴)_{3-z} [2]
   where
R³ is an alkyl, cycloalkyl, alkenyl or aryl radical having 1-10 carbon atoms,
R⁴ is an alkyl radical having 1-2 carbon atoms or an ω-oxaalkylalkyl radical having a total of 2-10 carbon atoms and
z is 0 or 1,
(B) blowing agents and
(C) solvents having a boiling point of at least 30° C.

It has been found that the viscosity of mixtures comprising silane-terminated prepolymers and blowing agents can be reduced significantly when small amounts of solvents having a boiling point above 30° C. are added to this mixture, without the resulting foams displaying cracks when foamed in the optionally previously moistened model join shown in FIG. 1. Foaming of the resulting mixtures (M) is as simple and unproblematical as that of conventional polyurethane foams.

The mixtures (M) are preferably isocyanate-free.

Preference is given to foamable mixtures (M) comprising prepolymers (A) which have alkoxysilyl groups of the general formula [3] 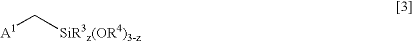
where
A¹ is an oxygen atom, an N—R⁵ group or a sulfur atom,
R⁵ is a hydrogen atom, an alkyl, cycloalkyl, alkenyl or aryl radical having 1-10 carbon atoms or a —CH₂—SiR³_{z}(OR⁴))_{3-z} group and
R³, R⁴ and z are as defined in the case of the general formula [2].

Particular preference is given to alkoxysilyl groups of the general formula [3] in which the heteroatom A¹ is part of a urea or urethane unit.

Preferred radicals R³ are methyl, ethyl or phenyl groups. The radicals R⁴ are preferably methyl groups and preferred radicals R⁵ are hydrogen, alkyl and alkenyl radicals having 1-10 carbon atoms, aspartate, cyclohexyl and phenyl radicals.

Particular preference is given to foamable mixtures comprising prepolymers (A) which have alkoxysilyl groups of the general formula [4] 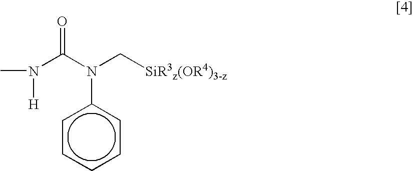
where R³, R⁴ and z are as defined in the case of the general formula [2].

In a likewise preferred embodiment of the invention, use is made of prepolymers (A) having chain ends of which 50-99% are alkoxysilyl groups of the formulae 2-4 and 1-50% are groups of the general formula [5],
A²-R⁶ [5]
where
A² is an oxygen atom, an N—R⁷ group or a sulfur atom,
R⁶ is an alkyl, cycloalkyl, alkenyl, aryl or arylalkyl radical having 2-50 carbon atoms, where the carbon chain may be interrupted as desired by nonadjacent oxygen atoms, sulfur atoms or N—R² groups and the main chain of the R⁶ can also be additionally substituted by lateral alkyl groups having 1-10 carbon atoms or halogen atoms, and
R⁷ and R² are each a hydrogen atom, an alkyl, alkenyl or aryl radical having 1-10 carbon atoms.

The heteroatom A² is preferably an oxygen atom. This oxygen atom is particularly preferably part of a urethane unit.

Preference is given to 65-95% of the chain ends of the prepolymers (A) being terminated by alkoxysilyl groups and 5-35% of the chain ends being terminated by groups of the general formula [5].

In a further preferred embodiment of the invention, halogen-containing polyols (A11) have been incorporated in the preparation of the prepolymers (A). This embodiment is particularly useful for the production of silane-crosslinking spray foams having an improved burning behaviour.

Possible blowing agents (B) are in principle all blowing gases known for spray foam applications and mixtures thereof. However, the blowing agent (B) preferably comprises at least 30% by volume, particularly preferably at least 50% by volume, of hydrocarbons. These hydrocarbons used in the blowing agent (B) preferably have 1-4 carbon atoms, particularly preferably 3-4 carbon atoms. As further typical blowing agent components, preference is given to adding 0.1-20%, particularly preferably 1-10%, of dimethyl ether to the blowing gas mixture (B). However, all further known blowing gases can also be added as additional components to the preferred blowing agent mixtures (B). Here, it is in principle also possible to use all fluorinated blowing agents such as 1,1,1,2-tetrafluoroethane, 1,1-difluoroethane, 1,1,1,2,3,3,3,-heptafluoropropane.

Particular preference is given to blowing agent mixtures (B) which consist exclusively of hydrocarbons, preferably propane/butane mixtures, and dimethyl ether. The dimethyl ether content is in this case preferably 0-20% by volume, particularly preferably 1-15% by volume.

As solvents (C), it is in principle possible to use all solvents and solvent mixtures having a boiling point of at least 30° C. Preference is given to solvents (C) having a boiling point of 40-200° C., with solvents having a boiling point of 60-150° C. being particularly preferred. Of course, it is also possible to use mixtures of various solvents.

Preference is given to using compounds which have a dipole moment of >0 as solvents (C). Particularly preferred solvents have a heteroatom having free electron pairs which can form hydrogen bonds. Particularly preferred solvents are alcohols, ethers and esters, in particular ethers and esters of aliphatic carboxylic acids and aliphatic alcohols, and aliphatic alcohols. A preferred ether is t-butyl methyl ether, preferred esters are ethyl acetate and butyl acetate, and preferred alcohols are methanol, ethanol and butanol. In a particularly preferred embodiment, secondary or tertiary alcohols such as t-butanol are used as solvent (C).

The solvent (C) is preferably added in concentrations of 0.1-20% by volume, based on the prepolymer (A). It is particularly preferably added in concentrations of 0.2-5% by volume, based on the prepolymer (A).

The main chains of the prepolymers (A) can be branched or unbranched. The mean chain lengths can be matched as desired to the properties desired in each case, e.g. viscosity of the uncrosslinked mixture (M) and hardness of the finished foam. The main chains can be organopolysiloxanes, e.g. dimethylorganopolysiloxanes, organosiloxane-polyurethane copolymers or organic chains, e.g. polyalkanes, polyethers, polyesters, polycarbonates, polyurethanes, polyureas, vinyl acetate polymers or copolymers. Of course, any mixtures or combinations of prepolymers (A) having different main chains can also be used. The use of organopolysiloxanes or organosiloxane-polyurethane copolymers, is desired in combination with further prepolymers having organic main chains, has the advantage that the resulting foams have a better burning behavior.

In a particularly preferred embodiment of the invention, the prepolymers (A) have a polyurethane nucleus. The preparation of these prepolymers (A) having a polyurethane nucleus preferably starts out from the following starting materials:
polyols (A1)
diisocyanates or polyisocyanates (A2),
if desired, monomeric alcohols having an OH function (A3)
alkoxysilanes (A4) which have either an isocyanate function or an isocyanate-reactive group.

As polyols (A1) for preparing the prepolymers (A) having a polyurethane nucleus, it is in principle possible to use all polymeric, oligomeric or monomeric alcohols having two or more OH functions and also mixtures thereof. Particularly suitable polyols (A1) are aromatic and/or aliphatic polyester polyols and polyether polyols as are widely described in the literature. The polyethers and/or polyesters used can be either linear or branched. In addition, they can also have substituents such as halogen atoms. Hydroxy-alkyl-functional phosphoric esters/polyphosphoric esters can also be used as polyols (A1). The use of any mixtures of the various types of polyol is likewise possible.

In a preferred embodiment of the invention, the polyols (A1) consist entirely or partly of halogenated polyols (A11). Particularly useful polyols (A11) are halogen-substituted aromatic or aliphatic polyesters or halogen-substituted polyether polyols. Here, preference is given to halogenated polyether polyols which can be prepared, for example, by reaction of chlorinated or brominated diols or oligools with epichlorohydrin. In a particularly preferred embodiment of the invention, a mixture of halogenated polyether polyols and nonhalogenated polyether polyols is used as component (A1).

Examples of useful diisocyanates (A2) are diisocyanato-diphenylmethane (MDI), both in the form of crude or technical-grade MDI and in the form of pure 4,4′ or 2,4′ isomers or mixtures thereof, tolylene diisocyanate (TDI) in the form of its various regioisomers, diisocyanatonaphthalene (NDI), isophorone diisocyanate (IPDI) and hexamethylene diisocyanate (HDI). Examples of polyisocyanates (A2) are polymeric MDI (P-MDI), triphenylmethane triisocyanate and biuret triisocyanates. The diisocyanates and/or polyisocyanates (A2) can be used individually or as mixtures.

The monomeric alcohols having a hydroxy function (A3) serve to incorporate the chain ends corresponding to the general formula [5] into the prepolymers (A). Here, it is in principle possible to use all alkyl, cycloalkyl, alkenyl, aryl or arylalkyl monoalcohols having 2-50 carbon atoms, in which the carbon chains of the alcohols may be interrupted in any desired way by nonadjacent oxygen atoms, sulfur atoms or N—R⁷ groups and the main chain may also be additionally substituted by lateral alkyl groups having 1-10 carbon atoms or halogen atoms. However, preference is given to using alkyl or alkenyl alcohols having 8-26 carbon atoms, particularly preferably alkyl alcohols having 10-18 carbon atoms. The carbon chains of these alcohols can be linear or branched, but they are preferably unbranched. It is possible to use pure alcohols or mixtures of various alcohols.

As alkoxysilanes (A4) for the preparation of the prepolymers (A) having a polyurethane nucleus, it is in principle possible to use all alkoxysilanes which have either an isocyanate function or an isocyanate-reactive group. The alkoxysilanes serve to incorporate the alkoxysilyl end groups into the prepolymers (A). As alkoxysilanes, preference is given to using compounds which are selected from among silanes of the general formulae [6] and [7] 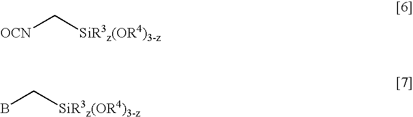
where
B is an OH, SH or NHR³ group and
R³, R⁵ and z are as defined in the case of the general formula [3].

It is possible to use individual silanes (A4) or mixtures of various silanes (A4).

Particular preference is given to using silanes (A4) of the general formula [8] 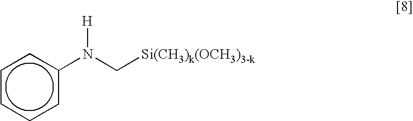
where
k is 0, 1 or 2.

This silane can be prepared without problems in only one reaction step by reaction of chloromethyltrimethoxysilane or chloromethyldimethoxymethylsilane with aniline, i.e. from very simple and inexpensive starting materials. When this silane is used, prepolymers (A) having alkoxysilyl end groups of the general formula [4] are obtained.

The prepolymers (A) are prepared by simply combining the components described with a catalyst being able to be added and/or elevated temperature being able to be employed if appropriate. The isocyanate groups of the diisocyanates and/or polyisocyanates and, if present, the isocyanate groups of the silane of the general formula [6] in this way react with the OH or NH functions of the polyols added and the monomeric alcohols and, if present, with the OH or NH functions of the silanes of the general formulae [7] and/or [8]. Owing to the relatively large quantity of heat involved in these reactions, it is usually advantageous to add the individual components gradually so as to be able to control the quantity of heat liberated more readily. The order of addition and rate of addition of the individual components can be as desired. It is also possible for the various raw materials to be initially charged or added either individually or in the form of mixtures. In principle, a continuous prepolymer preparation, e.g. in a tube reactor, is also conceivable.

The concentrations of all isocyanate groups participating in all reaction steps and all isocyanate-reactive groups and also the reaction conditions are selected so that all isocyanate groups react completely during the prepolymer synthesis. The finished prepolymer (A) is thus isocyanate-free. In a preferred embodiment of the invention, the concentration ratios and the reaction conditions are selected so that nearly all of the chain ends (>90% of the chain ends, particularly preferably >95% of the chains ends) of the prepolymers (A) are terminated either by alkoxysilyl groups or by radicals of the general formula [5].

In a particularly preferred process for preparing the prepolymers, the isocyanate component (A2) comprising one or more different diisocyanates/polyisocyanates is placed in a reaction vessel and admixed with a deficiency of a polyol (A1) or a mixture of a plurality of polyols (A1). These two components react at temperatures above 60-80° C. or in the presence of a catalyst to form an isocyanate-terminated prepolymer. This is subsequently admixed with one or more aminosilanes of the general formulae [7] and/or [8], with the concentrations being selected so that all isocyanate groups react. This results in a silane-terminated prepolymer. Purification or other work-up is not necessary.

Preference is likewise given to a process for preparing the foamable mixtures (M), in which the prepolymer synthesis is carried out entirely or at least partly in a pressure vessel, preferably in the foam can. In this case, the blowing agent and all further additives can also be added to the reaction mixture. In this way, the sometimes relatively highly viscous prepolymers (A) are produced in the presence of the blowing agent and a low-viscosity blowing agent/prepolymer solution or mixture is formed directly.

The reactions between isocyanate groups and isocyanate-reactive groups which occur in the preparation of the prepolymers (A) can, if appropriate, be accelerated by means of a catalyst. Preference is in this case given to using the same catalysts which are described below as curing catalysts (E) for the in-situ foam. If appropriate, the same catalyst or the same combination of a plurality of catalysts which catalyzes the preparation of the prepolymer can also be used as curing catalyst (E) for foam curing. In this case, the curing catalyst (E) is already present in the finished prepolymer (A) and does not have to be added in the compounding of the foamable mixture (M).

The foamable mixtures (M) can comprise not only the prepolymers (A), the blowing agents (B) and the solvents (C) but also any further (pre)polymers. These can likewise have reactive groups via which they are incorporated into the network being formed during curing of the foam. However, they can also be unreactive.

Apart from the prepolymers (A), the blowing agent (B) and the solvent (C), the mixtures (M) can further comprise a low molecular weight reactive diluent (D). The reactive diluent (D) is added to the mixtures (M) to achieve a further decrease in the viscosity of this mixture. In this case, up to 100 parts by weight, preferably from 1 to 40 parts by weight, of a low molecular weight reactive diluent (D) which has a viscosity of not more than 5 Pas at 20° C. and has at least one C₁-C₆-alkoxysilyl group per molecule can be present in the mixture (M) per 100 parts by weight of prepolymer (A).

Suitable reactive diluents (D) are in principle all low molecular weight compounds which have a viscosity of preferably not more than 5 Pas, in particular not more than 2 Pas, at 20° C. and have reactive alkoxysilyl groups via which they can be incorporated into the three-dimensional network being formed during curing of the foam. The reactive diluent (D) serves, in particular, to reduce the viscosity of any relatively high-viscosity prepolymer mixtures. It can be added during the synthesis of the prepolymers (A) and can thus also prevent the occurrence of any intermediates which have a high viscosity and are therefore difficult to handle. The reactive diluent (D) preferably has a sufficiently high density (by weight) of crosslinkable alkoxysilyl groups for it to be able to be incorporated into the network being formed during curing without resulting in a decrease in the network density.

Preferred reactive diluents (D) are the inexpensive alkyltrimethoxysilanes such as methyltrimethoxysilane and also vinyltrimethoxysilane or phenyltrimethoxysilane and their partial hydrolysates. A further preferred reactive diluent is the carbamatosilane of the general formula [9]: 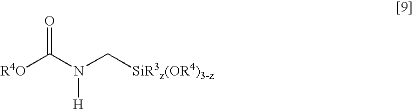
where R3, R⁴ and z are as defined in the case of the general formula [3].

To achieve rapid curing of the foam at room temperature, a curing catalyst (E) can be added if appropriate. As already mentioned, it is here possible to use, inter alia, the organic tin compounds customarily used for this purpose, e.g. dibutyltin dilaurate, dioctyltin dilaurate, dibutyltin diacetylacetonate, dibutyltin diacetate or dibutyltin dioctoate, etc. Furthermore, it is also possible to use titanates, e.g. titanium(IV) isopropoxide, iron(III) compounds, e.g. iron(III) acetylacetonate, or amines, e.g. aminopropyltrimethoxysilane, N-(2-aminoethyl)-aminopropyltrimethoxysilane, triethylamine, tributylamine, 1,4-diazabicyclo[2.2.2]octane, N,N-bis(N,N-dimethyl-2-aminoethyl)methylamine, N,N-dimethyl-cyclohexylamine, N,N-dimethylphenylamine, N-ethyl-morpholine, etc. Acids such as acetic acid, trifluoroacetic acid, phosphoric acid or benzoyl chloride can also be used. However, numerous further organic and inorganic heavy metal compounds and organic and inorganic Lewis acids or bases can also be used.

In a preferred application, catalysts (E) by means of which tack-free times of <3 minutes, particularly preferably <2 minutes, can be achieved are used. Suitable high-activity catalysts (E) are, in particular, strong acids such as hydrochloric acid, toluenesulfonic acid or benzoyl chloride and also strong bases such as 1,8-diazabicyclo[5.4.0]undec-7-ene, 1,5-diazabicyclo[4.3.0]non-5-ene. In another preferred embodiment, catalysts (E) by means of which tack-free times in the range from 3 to 20 minutes, particularly preferably from 3 to 15 minutes, can be achieved are used. For many applications, tack-free times in this medium time window are particularly useful. Suitable catalysts (E) having a moderate reactivity are, for example, partially esterified phosphoric acid derivatives such as butyl phosphate, dibutyl phosphate, isopropyl phosphate. For the present purposes, the tack-free time is the period of time elapsed after discharge of the foam into the air until the polymer surface is cured to a sufficient extent that when the surface is touched with a laboratory spatula no polymer composition remains adhering to the spatula and thread formation does not occur either (at 23° C., 50% rh).

In addition, the crosslinking rate can also be increased further or matched precisely to the particular need by means of a combination of various catalysts or of catalysts with various cocatalysts.

The mixtures (M) can further comprise the customary additives, for example foam stabilizers and cell regulators, flame retardants, thixotropes and/or plasticizers. As foam stabilizers, it is possible to use, in particular, the commercial silicone oligomers that have been modified by means of polyether side chains. Suitable flame retardants are, inter alia, the known phosphorus-containing compounds, especially phosphates and phosphonates, halogenated and halogen-free phosphoric esters and also halogenated polyesters and polyols or chloroparaffins.

The mixtures (M) can be used directly as one-component spray foams. The foamable mixtures (M) are preferably stored in pressure vessels such as pressure cans.

All the symbols used in the formulae above have their meanings independently of one another in each case. In all formulae, the silicon atom is tetravalent.

Unless indicated otherwise, all quantities and percentages in the following examples are by weight, and all pressures are 0.10 MPa (abs.) and all temperatures are 20° C.

FIG. 1 serves to illustrate some of the examples. The figure depicts a model join which consists of 2 wooden boards (1) having the dimensions 1×15×15 cm and 2 plastic beams (2) having the dimensions 2×2×17 cm.

### EXAMPLE 1

Preparation of N-phenylaminomethylmethyldimethoxysilane:

2095 g (22.5 mol) of aniline are placed in their entirety in a laboratory reactor and subsequently made inert by means of nitrogen. The aniline is heated to a temperature of 115° C. and 1159 g (7.5 mol) of chloromethylmethyldimethoxysilane are added dropwise over a period of 1.5 hours and the mixture is stirred for a further 30 minutes at 125-130° C. After addition of about 600 g of the silane, an increased amount of aniline hydrochloride precipitates as salt, but the suspension remains readily stirrable until completion of the addition.

The excess aniline is removed in a good vacuum (62° C. at 7 mbar). 1400 ml of n-heptane are subsequently added at room temperature and the suspension is stirred at 10° C. for 30 min in order to crystallize all the aniline hydrochloride. This is subsequently filtered off. The solvent n-heptane is removed at 60-70° C. in a partial vacuum. The residue is purified by distillation (89-91° C. at 0.16 mbar).

A yield of 1210 g, i.e. 76.5% of theory, is achieved at a product purity of about 94.5%. The product contains about 3.5% of N,N-bis[methyldimethoxysilylmethyl]-phenylamine as impurity.

### EXAMPLE 2

Preparation of Prepolymers (A):

232.2 g (1.333 mol) of tolylene 2,4-diisocyanate (TDI) are placed in a 2 1 reaction vessel provided with stirring, cooling and heating facilities and heated to about 50° C. A mixture of 264 g (0.621 mol) of a polypropylene glycol having a mean molar mass of 425 g/mol and 44 g (0.181 mmol) of 1-cetyl alcohol and 0.5 g of bis(2-morpholinoethyl) ether is then added. The temperature of the reaction mixture should not rise to above 80° C. The polypropylene glycol had been dewatered beforehand by heating at 100° C. in an oil pump vacuum for 1 hour. After the addition is complete, the mixture is stirred at 80° C. for 15 minutes.

The mixture is subsequently cooled to about 50° C. and 44 ml of vinyltrimethoxysilane are added as reactive diluent. 273.2 g (1.292 mol) of N-phenylaminomethyl-methyldimethoxysilane (prepared as described in example 1) are then added dropwise and the mixture is subsequently stirred at 80° C. for 60 minutes. Isocyanate groups can no longer be detected by IR spectroscopy in the resulting prepolymer mixture. A clear, transparent prepolymer mixture which has a viscosity of 8.2 Pas at 50° C. is obtained. It can be poured and processed further without problems.

### EXAMPLE 3

Preparation of Prepolymers (A):

26.6 g (153.0 mmol) of tolylene 2,4-diisocyanate (TDI) are placed in a 250 ml reaction vessel provided with stirring, cooling and heating facilities and heated to about 50° C. A mixture of 30 g (70.6 mmol) of a polypropylene glycol having a mean molar mass of 425 g/mol and a mixture of 1.67 g of 1-dodecanol (8.94 mmol), 1.67 g of 1-tetradecanol (7.77 mmol) and 1.67 g of 1-cetyl alcohol (6.87 mmol) is then added. (The advantage of the use of such a mixture of various long-chain alkyl alcohols is the melting point depression. This leads to the mixture of propylene glycol and the various alcohols remaining liquid down to about 10° C. without the alcohols crystallizing out as solids. Such an effect can be especially advantageous for carrying out the reaction on an industrial scale.) The temperature of the reaction mixture should not rise to above 80° C. The polypropylene glycol had been dewatered beforehand by heating to 100° C. in an oil pump vacuum for 1 hour. After the addition is complete, the mixture is stirred at 80° C. for 15 minutes. The mixture is subsequently cooled to about 50° C. and 5 ml of vinyltrimethoxysilane are added as reactive diluent. 31.0 g (146.9 mmol) of N-phenylamino-methylmethyldimethoxysilane (prepared as described in ex. 1) are then added dropwise and the mixture is subsequently stirred at 80° C. for 60 minutes. Isocyanate groups can no longer be detected by IR spectroscopy in the resulting prepolymer mixture. A clear, transparent prepolymer mixture which has a viscosity of 8.7 Pas at 50° C. is obtained. It can be poured and processed further without problems.

### EXAMPLE 4

Preparation of Prepolymers (A)

400.0 g (2.297 mol) of tolylene 2,4-diisocyanate (TDI) are placed in a 2 1 reaction vessel provided with stirring, cooling and heating facilities and heated to about 80° C. The heating is then removed and a mixture of 322.14 g (1.378 mmol) of IXOL M 125® (brominated polyol from Solvay) having an equivalent mass of 233.75 g/mol, 146.4 g (0.345 mol) of a polypropylene glycol having a mean molar mass of 425 g/mol and 19.89 g (0.077 mol) of a glycerol propoxylate having a mean molar mass of 260 g/mol is added at such a rate that the temperature does not rise to above 90° C. 80 ml of vinyltrimethoxysilane are then added as reactive diluent. After the addition is complete, the mixture is stirred at 70-80° C. for 30 minutes.

485.36 g (2.297 mol) of N-phenylaminomethylmethyl-dimethoxysilane (prepared as described in ex. 1) are subsequently added dropwise and the mixture is subsequently stirred at 70° C. for 120 minutes. Isocyanate groups can no longer be detected by IR spectroscopy in the resulting prepolymer mixture. A clear, transparent prepolymer mixture which has a viscosity of 9.4 Pas at 50° C. is obtained. It can be poured and processed further without problems.

### EXAMPLE 5

Production of a Foamable Mixture (According to the Invention)

50 g of the prepolymer mixture from example 2 are introduced into a pressure bottle with valve and admixed with 1.5 g of foam stabilizer B8443® (from Goldschmidt), 0.5 g of isopropyl phosphate as catalyst and 0.5 ml of ethyl acetate. 1 ml of dimethyl ether and 18 ml of a propane/butane mixture (having a propane/butane ratio of 2:1) are subsequently added to this mixture. Of these 18 ml of propane/butane, about 10 ml are soluble in the prepolymer. This solution forms a 2-phase mixture with the remaining 8 ml of propane/butane. Emulsions can be obtained from this mixture by simple shaking, and these emulsions can be foamed without problems and remain stable for a number of days. Even after demixing of this emulsion, the 2-phase mixture can be reemulsified without problems by renewed simple shaking. Shaking can be carried out in an easy fashion without application of excessive force; about 15-20 strokes are sufficient for excellent emulsification.

### EXAMPLE 6

Production of a Foamable Mixture (According to the Invention):

50 g of the prepolymer mixture from example 3 are introduced into a pressure bottle with valve and admixed with 1.5 g of foam stabilizer B8443® (from Goldschmidt), 0.1 g of benzoyl chloride as catalyst-and 1.0 ml of ethyl acetate. 1 ml of dimethyl ether and 18 ml of a propane/butane mixture (having a propane/butane ratio of 2:1) are subsequently added to this mixture. Of these 18 ml of propane/butane, about 10 ml are soluble in the prepolymer. This solution forms a 2-phase mixture with the remaining 8 ml of propane/butane. Emulsions can be obtained from this mixture by simple shaking, and these emulsions can be foamed without problems and remain stable for a number of days. Even after demixing of this emulsion, the 2-phase mixture can be reemulsified without problems by renewed simple shaking. Shaking can be carried out in an easy fashion without application of excessive force; about 15-20 strokes are sufficient for excellent emulsification.

### EXAMPLE 7

Production of a Foamable Mixture (According to the Invention):

50 g of the prepolymer mixture from example 2 are introduced into a pressure bottle with valve and admixed with 1.5 g of foam stabilizer B8443® (from Goldschmidt), 0.5 g of n-butyl phosphate as catalyst and 0.5 g of t-butyl methyl ether. 1 ml of dimethyl ether and 18 ml of a propane/butane mixture (having a propane/butane ratio of 2:1) are subsequently added to this mixture. Of these 18 ml of propane/butane, about 9.5 ml are soluble in the prepolymer. This solution forms a 2-phase mixture with the remaining 8.5 ml of propane/butane. Emulsions can be obtained from this mixture by simple shaking, and these emulsions can be foamed without problems and remain stable for a number of days. Even after demixing of this emulsion, the 2-phase mixture can be reemulsified without problems by renewed simple shaking. Shaking can be carried out in an easy fashion without application of excessive force; about 15-20 strokes are sufficient for excellent emulsification.

### EXAMPLE 8

Production of a Foamable Mixture (According to the Invention):

50 g of the prepolymer mixture from example 2 are introduced into a pressure bottle with valve and admixed with 1.5 g of foam stabilizer B8443® (from Goldschmidt), 0.1 ml of concentrated hydrochloric acid as catalyst and 1.0 g of n-heptane. 18 ml of a propane/butane mixture (having a propane/butane ratio of 2:1) are subsequently added to this mixture. Of these 18 ml of propane/butane, about 9 ml are soluble in the prepolymer. This solution forms a 2-phase mixture with the remaining 9 ml of propane/butane. Emulsions can be obtained from this mixture by simple shaking, and these emulsions can be foamed without problems and remain stable for a number of days. Even after demixing of this emulsion, the 2-phase mixture can be reemulsified without problems by renewed simple shaking. Shaking can be carried out in an easy fashion without application of excessive force; about 15-20 strokes are sufficient for excellent emulsification.

### EXAMPLE 9

Production of a Foamable Mixture (According to the Invention):

50 g of the prepolymer mixture from example 4 are introduced into a pressure bottle with valve and admixed with 1.2 g of foam stabilizer B8443® (from Goldschmidt), 0.3 ml of butyl phosphate as catalyst and 1 ml of t-butanol. 7 ml of 1,1,1,2-tetrafluoroethane and 6 ml of a propane/butane mixture (having a propane/butane ratio of 2:1) are subsequently added to this mixture. A clear solution is obtained.

### EXAMPLE 10

Production of a Foamable Mixture (Not According to the Invention):

50 g of the prepolymer mixture from example 2 are introduced into a pressure bottle with valve and admixed with 1.5 g of foam stabilizer B8443® (from Goldschmidt) and 0.5 ml of isopropyl phosphate as catalyst. 1 ml of dimethyl ether and 18 ml of a propane/butane mixture (having a propane/butane ratio of 2:1) are subsequently added to this mixture. Of these 18 ml of propane/butane, about 9 ml are soluble in the prepolymer. This solution forms a 2-phase mixture with the remaining 9 ml of propane/butane. Emulsions can be obtained from this mixture by shaking, and these emulsions can be foamed and remain stable for a number of days. Even after demixing of this emulsion, the 2-phase mixture can be reemulsified without problems by renewed simple shaking. Shaking can be carried out in an easy fashion without application of excessive force, but about 30-35 strokes are required for good emulsification.

### EXAMPLE 11

Production of a Foamable Mixture (Not According to the Invention):

50 g of the prepolymer mixture from example 2 are introduced into a pressure bottle with valve and admixed with 1.5 g of foam stabilizer B8443® (from Goldschmidt) and 0.5 ml of butyl phosphate as catalyst. 18 ml of a propane/butane mixture (having a propane/butane ratio of 2:1) are subsequently added to this mixture. Of these 18 ml of propane/butane, about 9 ml are soluble in the prepolymer. This solution forms a 2-phase mixture with the remaining 9 ml of propane/butane. Emulsions can be obtained from this mixture by vigorous shaking, and these emulsions can be foamed and remain stable for a number of days. Even after demixing of this emulsion, the 2-phase mixture can be reemulsified by renewed shaking. About 30-40 vigorous strokes are required for good emulsification.

### EXAMPLE 12

Production of a Foamable Mixture (Not According to the Invention):

50 g of the prepolymer mixture from example 2 are introduced into a pressure bottle with valve and admixed with 1.5 g of foam stabilizer B8443® (from Goldschmidt) and 0.1 ml of benzoyl chloride as catalyst. 2 ml of dimethyl ether and 18 ml of a propane/butane mixture (having a propane/butane ratio of 2:1) are subsequently added to this mixture. Of these 18 ml of propane/butane, about 9 ml are soluble in the prepolymer. This solution forms a 2-phase mixture with the remaining 9 ml of propane/butane. Emulsions can be obtained from this mixture by simple shaking, and these can be foamed without problems and remain stable for a number of days. Even after demixing of this emulsion, the 2-phase mixture can be reemulsified without problems by renewed simple shaking. The shaking can be carried out in an easy fashion without application of excessive force; about 15-20 strokes are sufficient for excellent emulsification.

### EXAMPLE 13

Production of a Foamable Mixture (Not According to the Invention):

50 g of the prepolymer mixture from example 2 are introduced into a pressure bottle with valve and admixed with 1.5 g of foam stabilizer B8443® (from Goldschmidt) and 0.1 ml of benzoyl chloride as catalyst. 9 ml of 1,1,1,2-tetrafluoroethane and 9 ml of a propane/butane mixture (having a propane/butane ratio of 2:1) are subsequently added to this mixture. A clear solution is obtained.

### EXAMPLE 14

Production of a Foamable Mixture (Not According to the Invention):

50 g of the prepolymer mixture from example 4 are introduced into a pressure bottle with valve and admixed with 1.2 g of foam stabilizer B8443® (from Goldschmidt) and 0.3 ml of butyl phosphate as catalyst. 7 ml of 1,1,1,2-tetrafluoroethane and 6 ml of a propane/butane mixture (having a propane/butane ratio of 2:1) are subsequently added to this mixture. A clear solution is obtained.

### EXAMPLE 15

Procedure for Foaming Tests

Discharge of the foamable mixture from examples 5-14 gives, without exception, stiff foams. A small plastic tube (length: about 20 cm, diameter: about 6 mm) is screwed onto the valve of the pressure vessel prior to foaming so that the foam can be discharged accurately and conveniently even into narrow joins. This method is also employed as a standard procedure in the case of conventional PU foams. All foaming tests were carried out at room temperature (about 23° C.).

The tack-free times depend exclusively on the catalysts used in the respective examples, and are reported in table 1. For the present purposes, the tack-free time is the period of time elapsed after discharge of the foam into the air until the polymer surface is cured to a sufficient extent that when the surface is touched with a laboratory spatula no polymer composition remains adhering to the spatula and thread formation does not occur either (at 23° C., 50% rh).

After not more than 6 hours, all foams were solid enough to cut (at foam thicknesses of about 5 cm). The cured foams without exception display a high hardness and are not brittle. If the foams are not foamed in a join, all foams display a very good pore structure.

The foam structures in the case of foaming in the model join as shown in FIG. 1 are indicated in table 1. In the table, the evaluation “crack-free” means that foams having an excellent pore structure and no cracks were obtained. The evaluation “small cracks” describes foams which have cracks which altogether make up less than 20% of the total volume of the join. The evaluation “large cracks” indicates foams having cracks which make up than 20% of the total volume of the join.

Table 1 likewise indicates the foaming behavior. Here, conventional PU spray foams by means of which even large volumes can be filled with foam in a relatively short time serve as measuring stick. Thus, the model join shown in FIG. 1 can be filled with conventional PU-spray foams without problems within 3 s. A foam which likewise allows a model join as shown in FIG. 1 to be filled in a maximum of 3 s is therefore designated as “good” in this respect in table 1. If, owing to a higher viscosity of the foamable mixture during foaming, a period of 5-10 s is required to fill the model join shown in FIG. 1 completely with foam, this foaming behavior is denoted by “moderate” in table 1. The evaluation “poor” indicates foams which are so viscous that more than 10 s are required to fill the model join shown in FIG. 1 completely with foam.

TABLE 1

| | Tack-free | | Foam | Foaming |
|---|---|---|---|---|
| | time | Color | structure | behavior |
| Example 5 | 5-8 min | white | crack- | good |
| according to | | | free | |
| the invention | | | | |
| Example 6 | 1-2 min | white | crack- | good |
| according to | | | free | |
| the invention | | | | |
| Example 7 | 8-10 min | white | crack- | good |
| according to | | | free | |
| the invention | | | | |
| Example 8 | 1-2 min | white | crack- | good |
| according to | | | free | |
| the invention | | | | |
| Example 9 | 4-6 min | slightly | crack- | good |
| according to | | yellowish | free | |
| the invention | | | | |
| Example 10 | 5-8 min | white | crack- | moderate |
| not according | | | free | |
| to the | | | | |
| invention | | | | |
| Example 11 | 8-10 min | white | crack- | poor |
| not according | | | free | |
| to the | | | | |
| invention | | | | |
| Example 12 | 1-2 min | white | small | good |
| not according | | | cracks | |
| to the | | | | |
| invention | | | | |
| Example 13 | 1-2 min | white | large | good |
| not according | | | cracks | |
| to the | | | | |
| invention | | | | |
| Example 14 | 4-6 min | slightly | crack- | poor |
| not according | | yellowish | free | |
| to the | | | | |
| invention | | | | |

1-11. (canceled)

12. A foamable composition comprising at least one isocyanate-free, alkoxysilane-terminated prepolymer, having silane end groups of the formula [2]
—SiR³_{z}(OR⁴)_{3-z} [2]
where
R³ is an alkyl, cycloalkyl, alkenyl or aryl radical having 1-10 carbon atoms,
R⁴ is an alkyl radical having 1-2 carbon atoms or an ω-oxaalkylalkyl radical having a total of 2-10 carbon atoms and
z is 0 or 1,
(B) at least one blowing agent, and
(C) at least one non-reactive solvent having a boiling point of at least 30° C.

13. The composition of claim 12, wherein at least one alkoxysilane-terminated prepolymer has silane end groups of the formula [3] 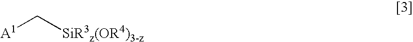
where
A¹ is an oxygen atom, an N—R⁵ group or a sulfur atom, and
R⁵ is a hydrogen atom, an alkyl, cycloalkyl, alkenyl or aryl radical having 1-10 carbon atoms or a —CH₂—SiR³_{z}(OR⁴))_{3-z} group.

14. The composition of claim 12, which is isocyanate-free.

15. The composition of claim 13, which is isocyanate-free.

16. The composition of claim 12, wherein at least one blowing agent (B) is selected from the group consisting of hydrocarbons having 1-4 carbon atoms and dimethyl ether.

17. The composition of claim 12, wherein at least one solvent (C) has a boiling point of 40-200° C.

18. The composition of claim 12, wherein at least one solvent (C) is selected the group consisting of among ethers, esters and alcohols.

19. The composition of claim 12, wherein the solvent(s) (C) are added in a total concentration of 0.1-20% by volume, based on the weight of the prepolymer (A).

20. The composition of claim 12, wherein the prepolymers (A) comprise a polyurethane and are obtained by reacting polyols with diisocyanates or polyisocyanates, and with alkoxysilanes which bear either an isocyanate group or an isocyanate-reactive group.

21. The composition of claim 20, wherein the polyols comprise halogenated polyols all or in part.

22. The composition of claim 12, which further comprises at least one partially esterified phosphoric acid derivatives as a catalyst.

23. A pressure vessel containing the foamable composition of claim 12.

24. A pressure vessel containing the foamable composition of claim 13.

25. A pressure vessel containing the foamable composition of claim 14.

26. A pressure vessel containing the foamable composition of claim 17.

27. A pressure vessel containing the foamable composition of claim 18.

28. A pressure vessel containing the foamable composition of claim 19.
